(19) United States
(12) Patent Application Publication
(10) Pub. No.: US 2013/0028999 A1
(43) Pub. Date: Jan. 31, 2013

(54) PROCESS AND DEVICE FOR THE CONTINUOUS PRODUCTION OF AN EXTRUDATE FROM FINELY DIVIDED PLANT MATERIAL AND A THERMOPLASTIC MATERIAL

(71) Applicants: Dieter Thewes, Troisdorf (DE); Andreas Reimann, Koln (DE); Stefan Feige, Siegburg (DE)

(72) Inventors: Dieter Thewes, Troisdorf (DE); Andreas Reimann, Koln (DE); Stefan Feige, Siegburg (DE)

(21) Appl. No.: 13/645,953

(22) Filed: Oct. 5, 2012

Related U.S. Application Data
(62) Division of application No. 12/734,200, filed on Jul. 23, 2010.

(30) Foreign Application Priority Data
Oct. 18, 2007 (DE) 10 2007 050 317
Feb. 23, 2008 (DE) 10 2008 010 796

(51) Int. Cl. B29C 47/36

(52) U.S. Cl. 425/131.1

(57) ABSTRACT

A device for continuous production of an extrudate from finely divided plant material and a thermoplastic material. When viewed in an extrusion direction, first the finely divided plant material and then the thermoplastic material are fed to an extrusion device, which can be a twin-screw extruder. The fed-in materials are mixed with one another, degassed and jointly extruded from the extrusion device and thus form the extrudate, and the plant material is embedded in the thermoplastic material, wherein the plant material and the thermoplastic material are fed into the extrusion device at a common position or two directly successive positions. The thermoplastic material is plastified in a separate plastifier extruder before being fed into the extrusion device and is fed from the extruder to the extrusion device in a plastified state, and the plant material is then degassed together with the thermoplastic material.

### CROSS REFERENCE TO RELATED APPLICATIONS

This application is a divisional of U.S. patent application Ser. No. 12/734,200, filed on 23 Jul. 2010, which is a National Phase entry of PCT/EP2008/007205. The co-pending parent application is hereby incorporated by reference herein in its entirety and is made a part hereof, including but not limited to those portions which specifically appear hereinafter.

### BACKGROUND OF THE INVENTION

1. Field of the Invention

This invention relates to a process and device for continuous production of an extrudate from a finely divided plant material and a thermoplastic material in which, viewed in an extrusion direction, first the finely divided plant material and then the thermoplastic material are fed into an extrusion device formed as a twin-screw extruder, the supplied materials are mixed with each other, degassed, and jointly extruded from the extrusion device, forming the extrudate, with the plant material embedded in the thermoplastic material.

2. Discussion of Related Art

Extrudates, for example in the form of continuously manufactured shaped components such as profiles, plates, and the like made of a finely divided plant material embedded in a thermoplastic material, are known and in particular, are usually referred to by the abbreviation WPC (wood-plastic composite).

Typically, WPC extrudates are composed of a wood-fiber or wood flour content of 50% to 90% and a plastic matrix composed of polypropylene (PP) or, less frequently, polyethylene (PE). Compared to pure wood materials, WPC extrudates have the advantage that their material can be freely shaped three-dimensionally and they have a significantly higher moisture resistance. WPC extrudates also have advantages compared to pure plastics, such as higher rigidities and significantly lower thermal expansion coefficients. Sample applications for such WPC shaped components include, for example, being used as a wood replacement for exterior floor coverings as well as applications in the construction field and furniture industry.

There is no uniform process guidance for manufacturing WPC extrudates of this type, in which the plant material should be completely embedded in the thermoplastic material, with the thermoplastic material thus forming the support matrix.

It is known from German Patent Reference DE 100 16 508 A1 to first supply the plastic compound to an extrusion device, compress and plasticize the plastic compound in the extrusion device, and then introduce the fibers into the molten plastic to then homogenize the fibers with the plastic compound and extrude the mixture to form the extrudate.

German Patent Reference DE 198 60 836 C1 discloses a process of a generic type in which first, the plant material is supplied to the extruder and for a certain period of time, is conveyed along in the extruder by itself, such as without the addition of the thermoplastic material, and is heated and compressed therein, thus removing moisture and only then is the plastic compound added.

The above-mentioned processes leave room for improvement with regard to the achievable outputs, a critical factor for the economical production of WPC extrudates. They also place high demands on the quality of the plant material used, particularly its moisture content, and in the event of fluctuating product quality, can lead to difficulties, sometimes to the extent that the supplied plant material will form clumps in the thermoplastic material, making it impossible to achieve the desired homogenization of the materials.

### SUMMARY OF THE INVENTION

One object of this invention is to provide a process and a device that make it possible to overcome the above-mentioned disadvantages of the prior art.

To attain the object, this invention provides a process with characteristics according to this invention as described in this specification and in the claims.

Other modifications and details of the teaching according to this invention are the subject of this described invention.

As proposed by this invention, the supply of the plant material and thermoplastic material into the extrusion device occurs at a common position or at two positions in immediate succession. Before being supplied to the extrusion device, the thermoplastic material is plasticized in a separate plasticizing extruder and is supplied by it to the extrusion device in an already plasticized state and then the plant material in the extrusion device is degassed together with the thermoplastic material.

In one embodiment according to this invention the finely divided plant material is first supplied to an extrusion device embodied in the form of a twin-screw extruder. Then, immediately thereafter or at the same time, the thermoplastic material is supplied to the extrusion device embodied in the form of a twin-screw extruder, with the thermoplastic material being already plasticized in a separate plasticizing extruder and thus being introduced into the extrusion device as a molten mass in fluid or at least paste-like form, at the pressure of the plasticizing extruder.

In the context of this invention, a “supply of the plant material and thermoplastic material at the same time or in immediate succession” is understood to mean that viewed in the extrusion direction, the plant material and the thermoplastic material are supplied to the extrusion device at the same position or at positions situated in immediate succession so that it is no longer necessary for the initially supplied plant material to be conveyed by itself for a certain distance in the extrusion direction and subjected to processing steps, such as a moisture removal. The distance between the immediately successive supply positions for the finely divided plant material and the thermoplastic material is determined solely by structural circumstances, for example by situating two supply pipes, each with its corresponding diameter, one immediately after the other in the extrusion direction. In the context of this invention, the expression “immediately successive” is understood to be distances from only a few mm up to 1-2 d, where d represents the diameter of each extruder screw.

In each case, the plant material and the thermoplastic material are supplied jointly in the so-called intake region of the extruder, the thermoplastic material having already been completely melted ahead of time in a plasticizing extruder and thus introduced into the extrusion device as a fluid or past-like molten mass under pressure.

The pressure produced at the output of the plasticizing extruder, at which the plasticized thermoplastic material is supplied to the extrusion device, is preferably less than 20 bar, particularly approximately 10 to 15 bar.

Because the individual supply positions of the finely divided plant material and the thermoplastic material are situated as close to each other as possible in the intake zone of the extrusion device, it is also possible to consider providing a reverse sequence, such as for the thermoplastic material, in an already plasticized state, to be supplied to the extrusion device first and immediately after it or at the same time, for the finely divided plant material to be supplied to the extrusion device.

The thermoplastic material used is preferably a polyolefin such as a polypropylene or a high-density polyethylene. It is also possible to use other thermoplastic materials such as polyamide or polyvinyl chloride.

The plant material can be any of the following materials, which are readily available in large quantities: wood fibers or wood flour, grain fibers, straw, natural fibers such as coconut or palm fibers, and MDF chips. These plant materials can be used individually or in mixtures with one another.

The percentage of supplied plant material comes to at least 50%, preferably at least 70% of the total so that the remaining portion is composed of the thermoplastic material and other processing agents as needed.

The plant material should have average particle sizes of less than 4 mm to permit good homogenization.

The process according to this invention places only slight demands on the moisture content of the plant material used. According to this invention, the plant material has a moisture content of less than 10%, preferably 5 to 8%. Moisture contents of this type are usually already present in commercially available plant materials of the kind provided for use in the device according to this invention, so that the process according to this invention functions properly without an additional moisture-removing step for the plant material used.

According to this invention, the moisture contained in the plant material is removed by degassing in the extrusion device. At the time of the degassing, the plant material is already mixed with the thermoplastic material that is supplied in the plasticized state.

In order to influence certain product properties of the manufactured extrudate and to facilitate processing, it is also possible, before being supplied to the extrusion device, for the plant material to be mixed with at least one additive, possibly including UV stabilizers, antifouling agents, fungicides, plant-protecting agents, flame retardants, colorants, or processing agents such as lubricants, and is then introduced, together with the plant material, into the extrusion device.

A device proposed within the scope of this invention, which is particularly suitable for carrying out the process according to this invention, includes an extrusion device embodied in the form of a twin-screw extruder, with an inlet opening and an outlet opening, and has a supply device for the plant material and thermoplastic material, which device is associated with the inlet opening, as well as a degassing opening situated between the inlet opening and outlet opening. The supply device includes two supply conduits that are situated in immediate succession to each other, in the extrusion direction, one of which is connected to a dispensing station for the plant material and the other of which is connected to a plasticizing extruder for the thermoplastic material.

Preferably, the first supply conduit, viewed in the extrusion direction, is used to supply the plant material and is thus connected to the dispensing station for the plant material while the immediately subsequent second supply conduit is connected to the plasticizing extruder for the thermoplastic material. It is also optionally possible to arrange them in the reverse order.

According to one embodiment of this invention, the extrusion device includes a twin-screw extruder with screws that rotate in opposite directions and preferably intermesh with each other.

According to another embodiment of this invention, the extrusion device can also comprise a twin-screw extruder with screws rotating in the same direction. If the pressure capacity of such a twin-screw extruder with screws rotating in the same direction is insufficient, then in this case, a subsequent melt pump can be provided to exert sufficient pressure for the extrusion of the extrudate through a corresponding die.

According to one embodiment of this invention, the plasticizing extruder for plasticizing the thermoplastic material and for supplying the already plasticized thermoplastic material into the extrusion device is in the form of a single-screw extruder and is connected to the supply device via a heatable connecting pipe.

Alternatively, the plasticizing extruder can also be embodied in the form of a multi-screw extruder, in particular a twin-screw extruder, which makes it possible not only to plasticize the thermoplastic material, but also to work fillers and additives into the thermoplastic material as needed. Such a twin-screw extruder used as a plasticizing extruder can have either screws that rotate in the same direction or with screws that rotate in opposite directions. For example, a twin-screw plasticizing extruder operating with screws that rotate in opposite directions is particularly suitable for processing a PVC dry blend.

The dispensing station can have at least one dispensing receptacle for plant material components, and embodying the station with a corresponding plurality of dispensing receptacles also makes it possible to process a plurality of different plant material components jointly. Preferably, the dispensing station also has at least one dispensing unit that can dispense colorants, additives, and/or processing agents and these materials can thus be supplied to the extrusion device together with the plant material components.

### DETAILED DESCRIPTION OF THE DRAWINGS

Other embodiments and details of this invention are explained in view of the drawing, wherein the FIGURE is a simplified schematic representation of an extrusion device embodied in the form of a twin-screw extruder having two screws that rotate in opposite directions and intermesh with each other.

### DETAILED DESCRIPTION OF THE INVENTION

At one end, the extrusion device 1 has an inlet opening 10 for the materials to be processed and at an other end, it has an outlet opening 11 that is followed by a die 5, not shown in detail, from which the produced extrudate 6 emerges in the direction of arrow P, in accordance with the extrusion direction indicated by arrow E.

The drawing also shows a plasticizing extruder 4 kept separate from the extrusion device 1 as well as a dispensing unit 3, the two communicating with the inlet opening 10 of the extrusion device 1, as explained in greater detail below.

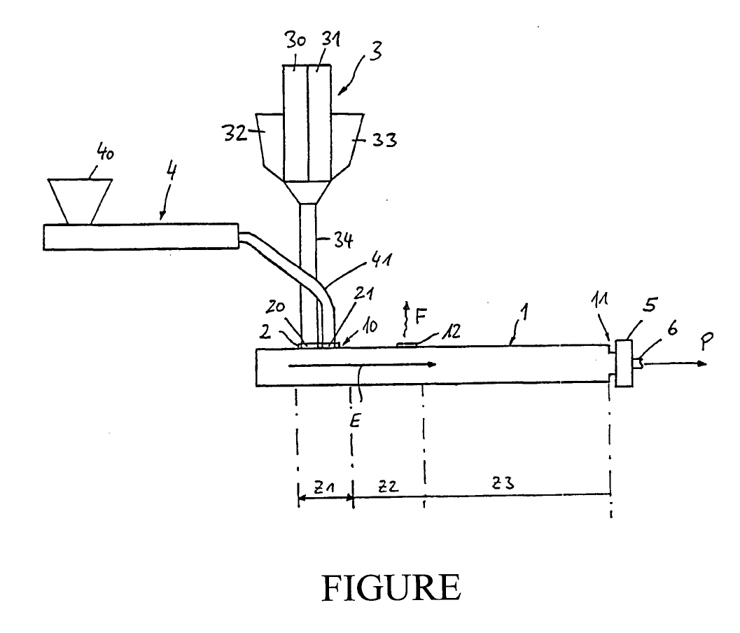

The inlet opening 10 of the extrusion device 1 has a supply device 2 with two supply conduits, a first supply conduit 20, viewed in the extrusion direction, and a second supply conduit 21 situated immediately downstream from it. Because both supply conduits 20, 21 communicate with the extrusion device 1 via the inlet opening 10, materials introduced via the supply conduits 20, 21 travel in the selected sequence into the intake zone of the extruder, which is labeled Z1 in FIG. 1.

In this case, the first supply conduit 20, viewed in the extrusion direction, is connected via a connecting pipe 34 to a dispensing station 3 that has a plurality of, such as two, dispensing receptacles 30, 31 for finely divided components of the plant material to be processed and also has a plurality of, such as two, dispensing units 32, 33 for colorants, additives, and/or processing agents. All of the components from the dispensing station 3 are introduced into the extrusion device 1 together via the connecting pipe 34 and the first supply conduit 20.

In addition, a separately provided plasticizing extruder 4, for example a single-screw extruder, is supplied via a feeder 40 with the thermoplastic material to be processed, such as pure polypropylene. The plasticizing extruder 4 takes this pure polypropylene and in an intrinsically known way, produces a polypropylene melt that the plasticizing extruder 4 supplies at an appropriate pressure of for example 10 to 15 bar via a heated connecting pipe 41 to the second supply conduit 21 of the supply device 2 for the extrusion device 1.

To this extent, the introduction of the molten and plasticized thermoplastic material also occurs in the intake zone Z1 of the extrusion device 1, in fact immediately after the supply of the plant material and other possible additives, colorants, and/or processing agents via the connecting pipe 34 and the first supply conduit 20.

The distance between the two supply conduits 20, 21 is approximately 1-2 d, where d represents the diameter of the screws, not shown, of the twin-screw extruder of the extrusion device 1.

In accordance with the operation of the twin-screw extruder of the extrusion device 1 in the direction of arrow E, the mixture that is output jointly into the zone Z1 is then homogenized in a second zone Z2. The moisture content in the supplied plant material is removed in opposition to atmospheric pressure via a degassing opening 12, which is situated between the inlet opening 10 and outlet opening 11 of the extrusion device 1. The contained moisture actually escapes via the degassing opening 12 as depicted by arrow F.

In the additional zone Z3, not shown, the mixture of plant material and thermoplastic material is blended further and is extruded at high pressure through the extrusion die 5, not shown in detail, to produce the desired strand-shaped extrudate 6, which exits the extrusion device 1 in the direction of arrow P.

The extrusion device 1 can be followed by other processing stations such as temperature-controlled forming plates, cooling zones, water spraying tanks, and saw units or the like.

### Exemplary Embodiment

A twin-screw extruder type BT 75-30D from the Reifenhauser company, with a screw diameter of 75 mm, a L/D ratio of 30, and two screws that rotate in opposite directions and intermesh with each other, was used as the plasticizing device 1.

A thermoplastic material in a quantity that constituted 20% of the extrudate obtained was plasticized in a single-screw plasticizing extruder and supplied to the extrusion device, while on the other hand, 80% of a finely divided wood flour with an average particle size of <4 mm was supplied to the extrusion device.

These two materials were extruded jointly to form a WPC extrudate in a profiled form, at a speed of approx. 1.5 m/min and a profile weight of approximately 2.5 kg/m.

The obtained extrudate had excellent homogenization of the supplied plant material in the thermoplastic material and good dimensional consistency.

What is claimed is:

1. A device for the continuous production of an extrudate from a finely divided plant material and a thermoplastic material, having an extrusion device (1) with a twin-screw extruder, having an inlet opening (10) and an outlet opening (11) and a supply device (2) for the plant material and the thermoplastic material which is associated with the inlet opening (10), and having a degassing opening (12) situated between the inlet opening (10) and the outlet opening (11), the device comprising the supply device (2) with two supply conduits (20, 21) situated in immediate succession to each other in the extrusion direction, the first supply conduit (20), viewed in an extrusion direction (E), is connected to a dispensing station (3) for the plant material and the second supply conduit (21) situated immediately thereafter is connected to a plasticizing extruder (4) for the thermoplastic material.

2. The device as recited in claim 1, wherein a distance between the two supply conduits (20, 21) in the extrusion direction is at most 2 d, where d represents a screw diameter of the extrusion device (1).

3. The device as recited in claim 2, wherein the extrusion device (1) is a twin-screw extruder with screws that rotate in opposite directions with respect to each other.

4. The device as recited in claim 3, wherein the extrusion device (1) is a twin-screw extruder having screws that rotate in a same direction as each other.

5. The device as recited in claim 4, wherein a melt pump is situated after the twin-screw extruder.

6. The device as recited in claim 5, wherein the plasticizing extruder (4) is a single-screw extruder.

7. The device as recited in claim 6, wherein the plasticizing extruder (4) communicates with the supply device via a heatable connecting pipe (41).

8. The device as recited in claim 5, wherein the plasticizing extruder (4) is a twin-screw extruder having screws that rotate in the same direction or in opposite directions.

9. The device as recited in claim 8, wherein the plasticizing extruder (4) communicates with the supply device via a heatable connecting pipe (41).

10. The device as recited in claim 9, wherein a dispensing station (3) has at least one dispensing receptacle (30, 31) for plant material components and at least one dispensing unit (32, 33) for colorants, additives, and/or processing agents.

11. The device as recited in claim 1, wherein the extrusion device (1) is a twin-screw extruder with screws that rotate in opposite directions with respect to each other.

12. The device as recited in claim 1, the extrusion device (1) is a twin-screw extruder having screws that rotate in a same direction as each other.

13. The device as recited in claim 1, wherein the plasticizing extruder (4) is a single-screw extruder.

14. The device as recited in claim 1, wherein the plasticizing extruder (4) is a twin-screw extruder having screws that rotate in the same direction or in opposite directions.

15. The device as recited in claim 1, wherein a dispensing station (3) has at least one dispensing receptacle (30, 31) for plant material components and at least one dispensing unit (32, 33) for colorants, additives, and/or processing agents.

16. A device for the continuous production of an extrudate from a finely divided plant material and a thermoplastic material, the device comprising:
an extrusion device (1) including a twin-screw extruder, an inlet opening (10), an outlet opening (11), and a degassing opening (12) situated between the inlet opening (10) and the outlet opening (11);
a first supply conduit (20) in combination with the inlet opening (10);
a plant material dispensing station (3) connected to at an end of the first supply conduit (2) that is opposite the inlet opening (10);
a second supply conduit (21) in combination with the inlet opening (10), and situated a distance downstream, viewed in an extrusion direction (E), of the first supply conduit (10) that less than or equal to two times a screw diameter of the extrusion device (1); and
a thermoplastic material plasticizing extruder (4) disposed at an end of the second supply conduit (21) that is opposite the inlet opening (10).

17. The device as recited in claim 16, wherein the plasticizing extruder (4) is a single-screw extruder.

18. The device as recited in claim 16, wherein the plasticizing extruder (4) is a twin-screw extruder having screws that rotate in the same direction or in opposite directions.

19. The device as recited in claim 16, wherein the dispensing station (3) has at least one dispensing receptacle (30, 31) for plant material components and at least one dispensing unit (32, 33) for colorants, additives, and/or processing agents.
